(19) United States
(12) Patent Application Publication
(10) Pub. No.: US 2024/0162510 A1
(43) Pub. Date: May 16, 2024

(54) ESTIMATION DEVICE, COMPUTER PROGRAM, AND ESTIMATION METHOD

(71) Applicant: GS Yuasa International Ltd., Kyoto-shi, Kyoto (JP)

(72) Inventor: Ryosuke TAKEHANA, Kyoto (JP)

(21) Appl. No.: 18/550,403

(22) PCT Filed: Feb. 22, 2022
(86) PCT No.: PCT/JP2022/007093

§ 371 Date: Sep. 13, 2023

(30) Foreign Application Priority Data
Mar. 18, 2021 (JP) 2021-044936

(51) Int. Cl. H01M 10/44; H01M 10/04

(52) U.S. Cl. CPC H01M 10/44; H01M 10/0409

(57) ABSTRACT

An estimation device includes: a determination unit configured to determine whether a shape change mode of an energy storage device is a first mode or a second mode; and an estimation unit configured to estimate a change in shape of the energy storage device in response to the shape change mode determined by the determination unit.

### CROSS REFERENCE TO RELATED APPLICATIONS

This application is a National Stage Application, filed under 35 U.S.C. § 371, of International Application No. PCT/JP2022/007093, filed Feb. 22, 2022, which international application claims priority to and the benefit of Japanese Application No. 2021-044936, filed Mar. 18, 2021; the contents of both of which as are hereby incorporated by reference in their entireties.

### BACKGROUND

### Technical Field

The present invention relates to an estimation device, a computer program and an estimation method.

### Description of Related Art

In forming a battery module from a plurality of cells (battery cells), there have been: a method of applying a pressing force to a plurality of cells in a state where long side surfaces of the plurality of cells face each other; a method of arranging a plurality of cells to face each other in a non-pressed state, and the like. In the latter method, there is a possibility that a case of the cell swells along with the use (charging-discharging) of the battery module.

Patent Document JP-A-2014-17141 discloses electronic equipment where the degree of swelling of a secondary battery is detected by a swelling detection unit attached to the secondary battery, and an alarm is transmitted to a user so that breaking of the battery module due to swelling of the secondary battery, the deterioration of performance of the battery module and the like can be prevented.

### BRIEF SUMMARY

It is considered that swelling of an energy storage device such as a secondary battery is mainly caused by a change in the element structure in the inside of the energy storage device and the generation of a gas in the energy storage device. To prevent breaking of a battery module due to swelling of an energy storage device, or to grasp a change of state and the deterioration brought about by swelling of the energy storage device, it is necessary to study a physical phenomenon in the energy storage device. For example, to facilitate the development of a model base, it is necessary to properly estimate a change in shape of an energy storage device by taking into account a physical phenomenon in the energy storage device

It is an object of the present invention to provide an estimation device, that estimates a change in shape of an energy storage device, a computer program, and an estimation method.

An estimation device according to one aspect of the present invention includes: a determination unit configured to determine whether a shape change mode of an energy storage device is a first mode or a second mode; and an estimation unit configured to estimate a change in shape of the energy storage device in response to the shape change mode determined by the determination unit.

According to the aspect described above, it is possible to properly estimate a change in shape of an energy storage device.

### BRIEF DESCRIPTION OF THE FIGURES

FIG. 1 is a perspective view of a battery module.

FIG. 2 is a perspective view of a cell.

FIG. 3 is a graph illustrating the relationship between the transition of a thickness of the cell and the transition of the element structure.

FIG. 4 is a view simulating a ¼ cross section of one of wound electrode assemblies housed in a cell case.

FIG. 5 is a graph illustrating a simulation result and an actually measured value of the transition of a thickness of the cell.

FIG. 6 is a view illustrating the relationship between the generation of wrinkles of the element structure and the transition of a shape change mode.

FIG. 7 is a graph illustrating a result of a simulation of the transition of a long side surface load.

FIG. 8 is a block diagram illustrating the configuration of an estimation device.

FIG. 9 is a graph illustrating a method of estimating a change in shape of an energy storage device when the energy storage device has been left (when electricity is not supplied to the energy storage device).

FIG. 10 is a graph illustrating a method of estimating a change in shape of an energy storage device when electricity is supplied to the energy storage device.

FIG. 11 is a graph illustrating the relationship between a first mode elapsed time expansion coefficient and a second mode elapsed time expansion coefficient and a temperature.

FIG. 12 is a graph illustrating the relationship between a first mode elapsed time expansion coefficient and a second mode elapsed time expansion coefficient and ΔSOC.

FIG. 13 is a graph illustrating the relationship between a first mode elapsed time expansion coefficient and a second mode elapsed time expansion coefficient and center SOC.

FIG. 14 is a flowchart illustrating a processing step of shape performed by an estimation device.

### DETAILED DESCRIPTION OF VARIOUS EMBODIMENTS

The estimation device includes: a determination unit for determining whether a shape change mode of an energy storage device is a first mode or a second mode; and an estimation unit for estimating a change in shape of the energy storage device in response to the shape change mode determined by the determination unit.

A computer program causes a computer to perform processing where the computer determines whether the shape change mode of the energy storage device is a first mode or a second mode, and estimates a change in shape of the energy storage device in response to the determined shape change mode.

An estimation method determines whether a shape change mode of an energy storage device is a first mode or a second mode, and estimates a change in shape of the energy storage device in response to the determined shape change mode.

The determination unit of the estimation device described above determines whether the shape change mode of the energy storage device is in a first mode or in a second mode.

The present inventors have found that at least two modes exist with respect to a change in shape of the energy storage device. Specifically, the present inventors have found that there exist at least two modes with respect to a change in shape of the energy storage device as ruling factors of a change in shape of an electrode assembly (element). The determination unit determines whether the shape change mode of the energy storage device is in the first mode or in the second mode based on the predetermined condition.

The estimation unit estimates a change in shape of the energy storage device in response to the shape change mode determined by the determination unit. By preparing a shape change estimation method of the energy storage device in the respective shape change modes in advance, an optimum method can be adopted corresponding to the shape change mode, and a change in shape of the energy storage device can be estimated with high accuracy.

The energy storage device may include a wound electrode assembly.

The present inventors have found out, as described later, that the energy storage device that includes a wound electrode assembly generates a unique shape change mode. With respect to the energy storage device that includes the wound electrode assembly, a change in shape can be estimated with high accuracy by grasping the shape change mode. Alternatively, the energy storage device may be an electrode assembly of a stacked type.

The estimation device may perform the estimation such that a shape change speed in the above-mentioned second mode shifted from the above-mentioned first mode becomes larger than a shape change speed in the above-mentioned first mode.

The shape change speed can be expressed, for example, in the form of (shape change amount/time) or (shape change amount/total SOC change amount). With the configuration described above, a change in shape of the energy storage device can be accurately estimated over before and after the shift of the mode.

The estimation device may include a first acquisition unit that acquires or calculates a progress parameter relating to an elapsed period of the energy storage device, and the determination unit may determine the shape change mode based on the progress parameter acquired or calculated by the first acquisition unit.

The progress parameter relating to the elapsed period of the energy storage device may be a parameter for determining whether the shape change mode of the energy storage device is the first mode or the second mode. With the configuration described above, a change in shape of the energy storage device can be accurately estimated.

The estimation device may include: a second acquisition unit that acquires or calculates a progress parameter relating to the supply of electricity to the energy storage device; and the determination unit may determine the shape change mode based on the progress parameter acquired or calculated by the second acquisition unit.

The progress parameter relating to the supply of electricity to the energy storage device may be a parameter for determining whether the shape change mode of the energy storage device is the first mode or the second mode. With the configuration described above, a change in shape of the energy storage device can be accurately estimated.

The progress parameter may include any one of the number of elapsed days in the time period during which electricity is not supplied to the energy storage device or in the time period during which electricity is supplied to the energy storage device, absolute values of sizes of the energy storage device, a change amount of the shape of the energy storage device, and a total SOC change amount of the energy storage device.

For example, by formulating a change in shape in advance as a function of time, the value of the change in shape can be obtained corresponding to the time period (the number of elapsed days). If the number of elapsed days is equal to or less than the threshold, it can be determined that the shape change mode is the first mode, and if the number of elapsed days exceeds the threshold, it can be determined that the shape change mode is the second mode. The function that indicates the change in shape differs between the first mode and the second mode.

The progress parameter may be absolute values of sizes of the energy storage device, a change amount of the shape of the energy storage device, or a total SOC change amount of the energy storage device. If the absolute values of the sizes or the change amount of the shape are equal to or less than the threshold values, it can be determined that the shape change mode is the first mode, and if the absolute values of the sizes or the change amount of the shape exceed the threshold value, it can be determined that the shape change mode is the second mode. Alternatively, when the total SOC change amount of the energy storage device exceeds a threshold, it can be determined that the shape change mode is the second mode.

The determination unit may determine the shift from the first mode to the second mode in response to a type of at least one of a positive active material and a negative active material of the energy storage device.

In the case of a lithium ion battery, lithium ions are adsorbed into the active material or lithium ions are desorbed from the active material along with charging or discharging. A shape change speed differs depending on whether a type of at least one of the positive active material and the negative active material is an active material exhibiting a large change in volume at the time of adsorption or desorption of ions or an active material exhibiting a small change in volume at the time of adsorption or desorption of ions. Accordingly, it is preferable to determine the shift from the first mode to the second mode in response to the type of the active material. It is considered that the energy storage devices having different active materials differ from each other in a shifting point of time from the first mode to the second mode even if these energy storage devices have the same use environment, the same sizes, and the same element structure.

The above-mentioned change in shape may include a change in thickness of the wound electrode assembly.

The thickness direction is a direction orthogonal to the winding axis direction of the wound electrode assembly (the direction orthogonal to the long side surface of the energy storage device). The present inventors have found out, as described later, that the energy storage device that includes a wound electrode assembly generates a unique shape change mode in the thickness direction. With the configuration described above, a change in thickness of the energy storage device can be estimated with high accuracy.

Hereinafter, embodiments of an estimation device, a computer program, and an estimation method will be described with reference to the drawings.

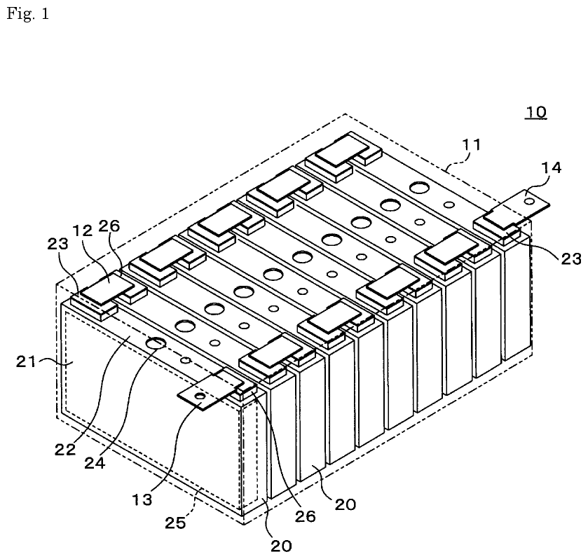

FIG. 1 is a perspective view illustrating an energy battery module (energy storage apparatus) 10. The battery module 10 includes: a case 11 having a rectangular parallelepiped shape; and a plurality of cells (energy storage devices) 20 accommodated in the case 11 in a non-depressed state.

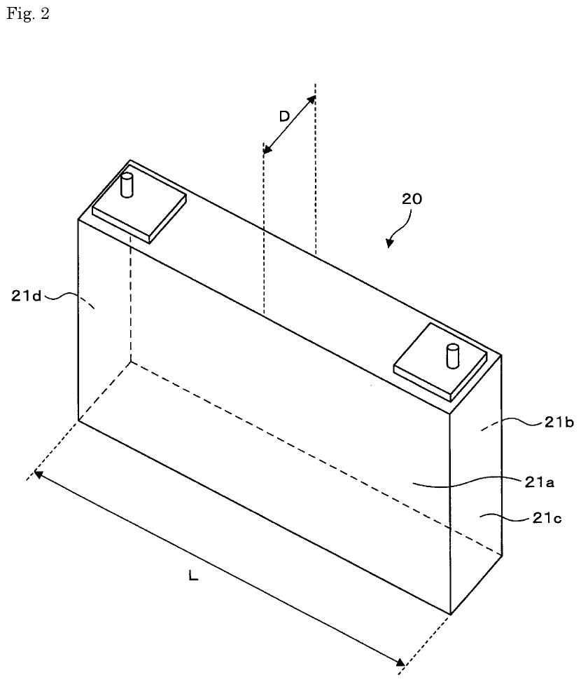

The cell 20 includes a cell case 21 having a rectangular parallelepiped (prismatic) shape, a lid plate 22, terminals 23, 26 mounted on the lid plate 22, a rupture valve 24, an electrode assembly 25 and the like. The terminals 23, 26 may be welded terminals as illustrated in FIG. 1 or bolt terminals as illustrated in FIG. 2. The electrode assembly 25 is also referred to as an element, and the wound electrode assembly is configured by winding a positive electrode plate, a separator, and a negative electrode plate in a flat shape in a state where the positive electrode plate, the separator, and the negative electrode plate overlap with each other. The electrode assembly 25 of a longitudinal winding type is accommodated in the cell case 21 in a posture where a winding axis direction of the electrode assembly 25 is parallel to the lid plate 22. The electrode assembly 25 of a lateral winding type is accommodated in the cell case 21 in a posture where a winding axis direction of the electrode assembly 25 is orthogonal to the lid plate 22. Alternatively, the electrode assembly 25 may be a stacked electrode assembly.

The positive electrode plate is formed by forming an active material layer on a positive electrode substrate material foil which is a plate-like (sheet-like) or elongated strip-like metal foil made of metal such as aluminum, an aluminum alloy or the like. The negative electrode plate is formed by forming an active material layer on a negative electrode substrate material foil which is a plate-like (sheet-like) or elongated strip-like metal foil made of metal such as copper, a copper alloy or the like. The separator is a microporous sheet made of a synthetic resin.

As the positive active material, for example, a material capable of occluding and releasing Li, such as a lithium transition metal oxide (Li1+aMeO₂, a≥1, Me contains one or more transition metal elements such as Ni, Mn, and Co) such as lithium cobalt oxide, lithium nickel manganese cobalt oxide, or lithium nickel cobalt aluminum oxide, spinel type lithium manganese oxide (LiMe₂O₄:Me being at least one metal element containing Mn), lithium iron phosphate, lithium iron manganese phosphate, or lithium vanadium phosphate, may be used. Two or more of these materials may be used in combination.

As the negative active material, for example, a material capable of occluding and releasing Li, such as graphite, hard carbon, soft carbon, metal Li, silicon monoxide, silicon or an alloy thereof, tin or an alloy thereof, lithium vanadate, tungsten oxide, titanium oxide, or niobium oxide, may be used. Two or more of these materials may be used in combination. The present invention is applicable as long as any one of the positive active material and the negative active material swells along with charging or discharging.

By electrically connecting the terminals 23, 26 of the cells 20 of the battery module 10 that are disposed adjacently to each other using bus bars 12, the plurality of cells 20 are connected to each other in series. Leads 14, 13 for taking out electricity from the battery module 10 are mounted terminals 23, 26 of the cells 20 disposed at both ends of the battery module 10.

FIG. 2 is a perspective view of the cell 20. The cell case 21 has long side surfaces 21a, 21b that are disposed on sides opposite to each other, and short side surfaces 21c, 21d that are disposed on sides opposite to each other. A size between the long side surfaces 21a, 12b indicated by a reference numeral D is referred to as a thickness (thickness), and a size between the short side surfaces 21c and 21d indicated by a reference numeral L is referred to as a length. There exists a relationship of length L>thickness D. In this present embodiment, mainly assume a change in thickness (thickness) D as a change in shape of the cell 20 (energy storage device).

The present inventors have established a hypothesis that at least two modes exist in a change in shape (mainly a change in thickness D) of the cell 20, and have found out that this hypothesis is sufficiently well grounded. The above-mentioned finding is specifically described hereinafter.

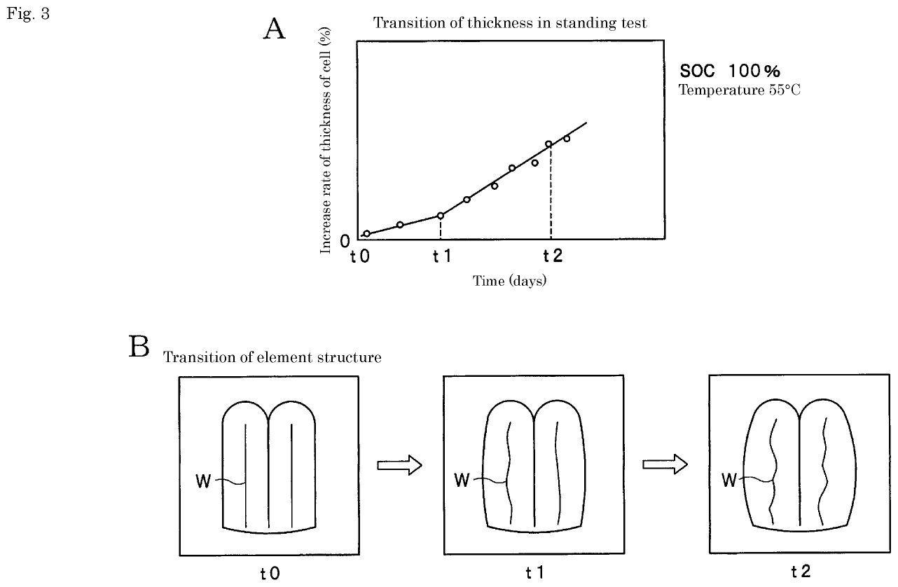

FIG. 3 is a graph illustrating the relationship between the transition of the thickness of the cell 20 and the transition of the element structure. FIG. 3A is a chart showing the transition of the thickness of the cell 20 in a standing test. In the standing test, a state of charge (SOC) of the cell 20 was set to 100%, the cell was left standing in an environment at a temperature of 55° C., and the transition of the thickness D was actually measured. Time (days) is taken on an axis of abscissas, and an increase rate (%) of the thickness of the cell 20 is taken on an axis of ordinates A point of time t0 is the start point of time of the standing test. As illustrated in FIG. 3A, the increase rate of the thickness of the cell 20 changes around a point of time t1. Specifically, the thickness change speed after the point of time t1 (from the point of time t1 to a point of time t2) is larger than the thickness change speed from the point of time t0 to the point of time t1. That is, the change in shape of the cell 20 proceeds in two stages.

FIG. 3B is a chart showing the transition of the element structure (In the present embodiment, two vertically wound electrode assemblies accommodated in the cell case and arranged close to each other) of the cell 20, and the three charts schematically show the state inside the cell case at points of time t0, t1, and t2 in FIG. 3A. A line denoted by a reference numeral W denotes a slit existing in a winding start portion of the innermost periphery of the electrode assembly 25. The slit W appears as if a thin line in the cross-sectional views of FIG. 3B. The slit W extends in the winding axis direction (direction perpendicular to a surface of a sheet of paper on which FIG. 3B is drawn). At a point of time t0, the slit W is formed in a straight-line shape. The thickness of the cell 20 is increased from the point of time t0 to the point of time t1, and at the point of time t1, wrinkles are generated in the element structure and hence, the slit W is bent. Further, an outermost periphery of the electrode assembly 25 swells. Still further, after the point of time t1, the thickness change speed is increased, the wrinkles inside the element structure are further increased and hence, the deformation of the slit W also is increased. An outermost periphery of the electrode assembly 25 further swells.

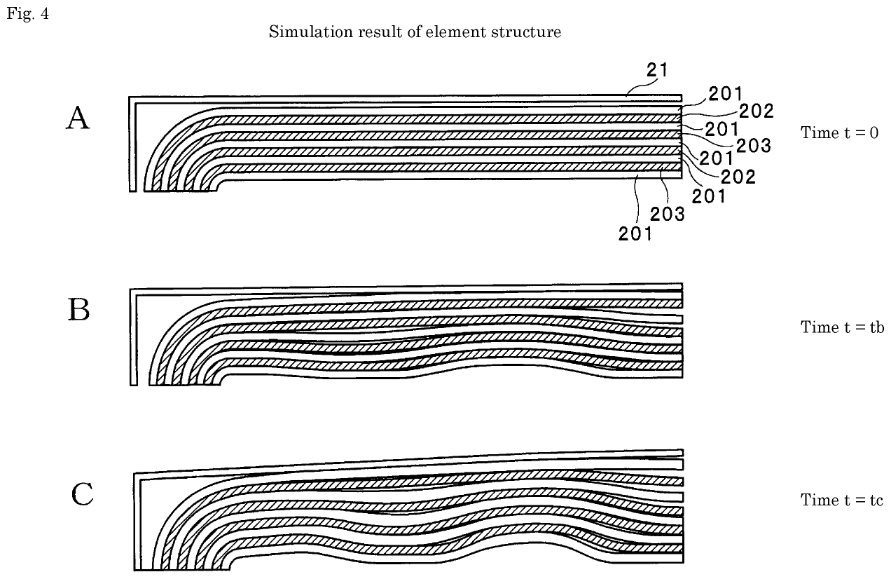

FIG. 4 illustrates a result of a computer aided engineering (CAE) simulation performed for confirming a cause of the progress of a change in shape of the cell 20 in two stages.

FIG. 4 is a view simulating a ¼ cross section of one of wound electrode assemblies housed in the cell case 21. In FIG. 4, reference numeral 201 denotes a separator, reference numeral 202 denotes a positive electrode, and reference numeral 203 denotes a negative electrode. In the element structure in the cell case 21, the positive electrode 202, the separator 201, and the negative electrode 203 are wound in an overlapping manner. Such a 2DCAE model (two-dimensional CAE model) was created based on physical property values (for example, a thickness, a Young's modulus, a Poisson's ratio, a linear expansion coefficient, a proof stress, and the like) and design values of materials (a separator, a positive and negative electrode composite, a foil, and the like) that construct the cell case 21 and the element structure. The swelling of the element structure was reproduced by increasing the thickness of the positive and negative electrode composite (for example, the transition of the increase of thickness that is an actually measured value being used). FIGS. 4A, 4B, and 4C illustrate cross sections of the element structure at respective points of time (elapsed times) t=0, t=tb, and t=tc). As illustrated in FIG. 4, wrinkles are formed in the element structure near the point of time t=tb. Then, the deformation is gradually increased from the point of time t=tb to the point of time t=tc.

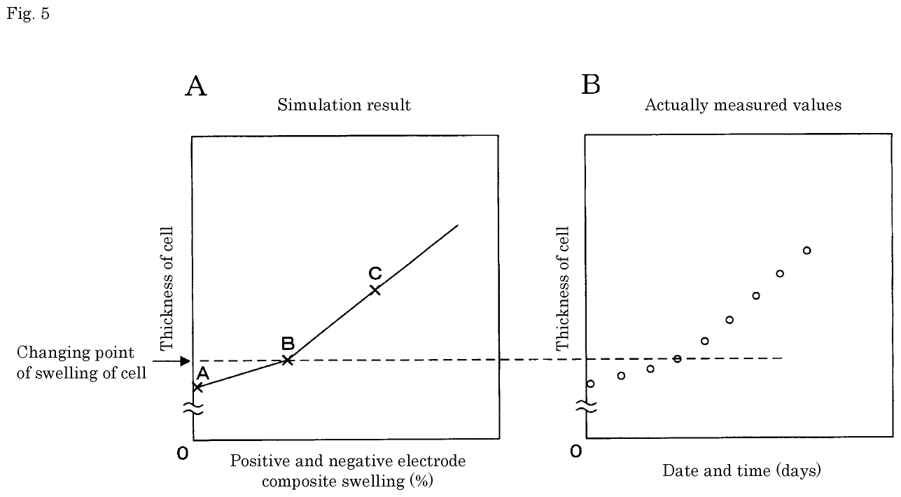

FIG. 5 is a graph illustrating a simulation result and an actually measured value of the transition of the thickness of the cell 20. In the simulation result illustrated in FIG. 5A, the positive and negative electrode composite swelling (%) is taken on an axis of abscissas, and the thickness of the cell is taken on an axis of ordinates. In FIG. 5A, points A, B, and C denoted by reference numerals respectively correspond to the states of the element structure illustrated in FIG. 4A, FIG. 4B, and FIG. 4C respectively. With respect to the actually measured value (in the standing test at an SOC of 100% and a temperature of 45° C.) illustrated in FIG. 5B, time (days) is taken on an axis of abscissas, and the thickness of the cell is taken on an axis of ordinates. In FIG. 5B, points denoted by dots indicate the actually measured values.

Similarly to the actually measured value, the simulation result indicates that the swelling mode (shape change mode) is changed at a changing point of swelling of the cell that forms a boundary. That is, a shape change speed after the changing point is larger than a shape change speed in a shape change mode (also referred to as “first mode”) from an initial stage to the change point. This result implies that a change in increase rate (shape change speed) of the thickness of the cell depends on the swelling of the element structure. This result suggests that there exist at least two modes with respect to the change in shape of a part (mainly the positive and negative electrode composite) of the element structure (for example, the positive and negative electrode composite, the positive and negative electrode current collectors, the separator and the like) of the energy storage device.

Next, the relationship between the generation of wrinkles and the change in the shape change mode will be considered.

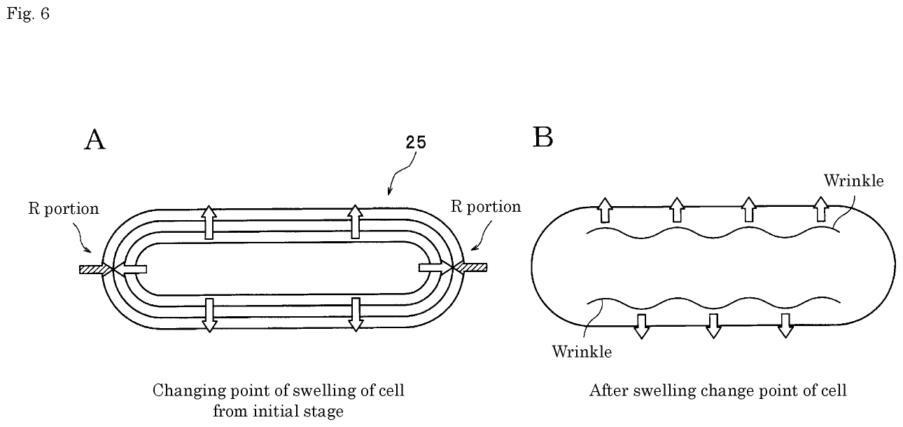

FIG. 6 is a view illustrating the relationship between the generation of wrinkles on the element structure and the transition of a shape change mode. FIG. 6A illustrates a change in shape of the element structure from an initial stage to a stage near the change point at which the cell swells (when the shape change mode is the first mode), and FIG. 6B illustrates a change in shape of the element structure after the change point at which the cell swells (when the shape change mode is the second mode). As described above, in the electrode assembly 25, the positive electrode, the negative electrode and the separator are wound around a flat plate referred to as a winding core, and the winding core is removed when the winding is finished. With such a configuration, a straight slit is formed in a center portion of the electrode assembly 25.

As illustrated in FIG. 6A, when the cell 20 is left or supplied with electricity (charged and/or discharged) and, thereafter, time elapses, the positive electrode and the negative electrode gradually swell. Accordingly, the electrode assembly 25 is likely to swell outward. On the other hand, a circumferential length of the outermost profile of the electrode assembly 25 does not change. When the positive electrode and the negative electrode swell, a reaction occurs in arc portions (rounded portions or an R portions). As a result, the positive electrode plate and/or the negative electrode plate (also referred to as “plates”) are pushed inward. Accordingly, flat portions of the electrode assembly 25 are pushed outward (the first mode).

As illustrated in FIG. 6B, when the time further elapses, the plates are continuously pushed inward due to the reaction at the R portions and the electrode assembly 25 intends to swell. In this case, the directions that the plates can escape by swelling are limited to only the directions toward to the flat portions of the electrode assembly 25. As a result, the plates start to bend toward the flat portions and wrinkles are generated in the plates. Due to the generation of the wrinkles, the plates become more easily bendable and hence, a speed of a change in shape (a change in thickness) is increased (second mode).

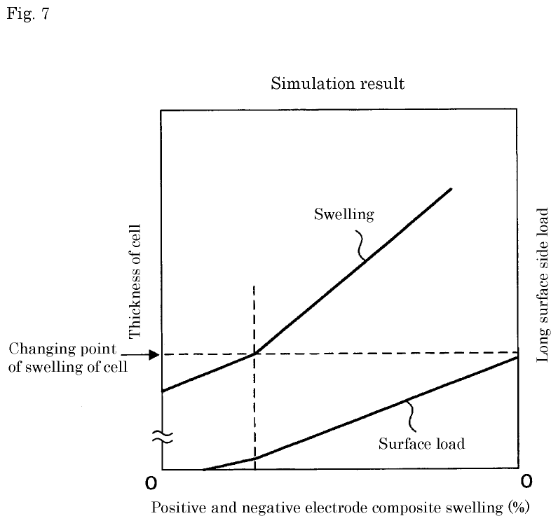

FIG. 7 is a graph illustrating the result of a simulation of the transition of a long side surface load. In FIG. 7, the swelling (%) of the positive and negative electrode composite is taken on an axis of abscissas, and the thickness and the long-side load of the cell are taken on an axis of ordinates. The long side load is a load that is generated when the flat portion of the electrode assembly 25 is pushed outward in FIG. 6. As illustrated in FIG. 7, a change mode of a load that the electrode assembly 25 applies to a long side surface of the cell case 21 is also changed before and after the change point of the swelling of the cell.

In this embodiment, by taking swelling of the cell having the wound electrode assembly as an example, the description has been made with respect to the prediction of a change in shape of the energy storage device by taking into account the finding that the swelling manner of the cell changes from the first mode to the second mode depending on the degree of the formation of wrinkles on the electrode assembly. Alternatively, for example, the present invention is also applicable to the following case that occurs in a cell having an electrode assembly of a stacked type. That is, the present invention is applicable to the case where the manner of swelling (the shape change mode) of an electrode changes. For example, an active material is gradually pulverized along with charging and discharging so that a specific surface area is increased and hence, a mode of a generation amount of deposits that are precipitated on an electrode or a mode of a generation amount of a gas in a battery changes.

Next, the configuration of an estimation device will be described.

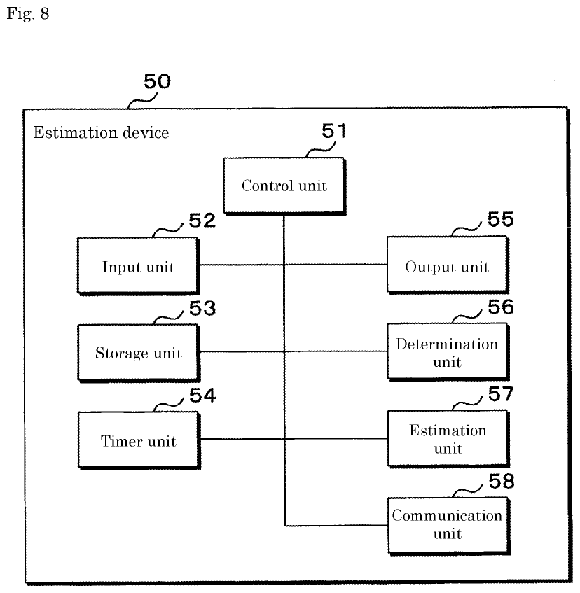

FIG. 8 is a block diagram illustrating the configuration of an estimation device 50. The estimation device 50 includes a control unit 51 that controls the entire energy storage apparatus, an input unit 52, a storage unit 53, a timer unit 54, an output unit 55, a determination unit 56, an estimation unit 57, and a communication unit 58. The control units 51 may be configured by a central processing unit (CPU), a read only memory (ROM), a random access memory (RAM), and the like. The storage unit 53 is configured by a hard disk, a semiconductor memory, or the like, and stores necessary data.

The input unit 52 acquires time-series data of an energy storage device (for example, the cell 20) that is a subject whose change in shape is to be estimated. The estimation of a change in shape of the energy storage device may be applied to a plurality of energy storage devices. The time-series data includes, for example, time-series data of voltages, currents, and temperatures of the energy storage device. The input unit 52 acquires time data besides the time series data. The time data may be any data that indicates a start point and an end point of an estimation period for estimating a change in shape. When the energy storage device is in a standing state, it is sufficient for the input unit 52 to acquire only time data. When the energy storage device is in an electricity supply state, the input unit 52 acquires time series data within the estimation period together with the time data. The time series data may be actually measured values or calculated values. The data acquired by the input unit 52 may be stored in the storage unit 53.

The control unit 51 specifies a ΔSOC (state of charge) and a center SOC of the energy storage device based on the time-series data acquired by the input unit 52. The ΔSOC is a difference between a maximum value and a minimum value of the SOC that changes based on charging to or discharging from the energy storage device. The center SOC is an average of the SOC that changes its value.

The timer unit 54 counts an elapsed time at the time of estimating a change in shape of the energy storage device.

The determination unit 56 determines whether the shape change mode of the energy storage device is a first mode or a second mode. More specifically, the determination unit 56 determines whether the shape change mode of the energy storage device is in the first mode or in the second mode based on a predetermined condition.

The estimation unit 57 estimates a change in shape of the energy storage device in response to the shape change mode determined by the determination unit 56. By preparing a shape change estimation method of the energy storage device in the respective shape change modes in advance, an optimum method can be adopted corresponding to the shape change mode, and a change in shape of the energy storage device can be estimated with high accuracy.

The output unit 55 outputs an estimation result acquired by the estimation unit 57 to an external device (for example, a display device, a printing device or the like).

The communication unit 58 includes a necessary communication module, and performs transmission and reception of data and information between the estimation device 50 and an external apparatus. For example, the communication unit 58 performs the reception, updating of an application (program) that specifies processing of the estimation device 50, and the reception and updating of respective se coefficients described later.

Hereinafter, the estimation of a change in shape of the energy storage device will be described in detail.

The present inventors have found out that the energy storage device that includes a wound electrode assembly generates a unique shape change mode. With respect to the energy storage device that includes the wound electrode assembly, a change in shape can be estimated with high accuracy by grasping the shape change mode. The shape of the energy storage device changes in accordance with the first mode from an initial stage to a mode shifting point of time (a change point of cell swelling) and, thereafter, the shape of the energy storage device changes in accordance with the second mode. The change in shape of the energy storage device is appropriately estimated in response to whether an estimation point of time is before or after the mode transition point of time.

The estimation device may perform the estimation such that a shape change speed in the second mode that is a mode shifted from the first mode becomes larger than a shape change speed in the first mode. The shape change speed can be expressed, for example, in the form of (shape change amount/time) or (shape change amount/total SOC change amount). With the configuration described above, a change in shape of the energy storage device can be accurately estimated over before and after the shift of the mode.

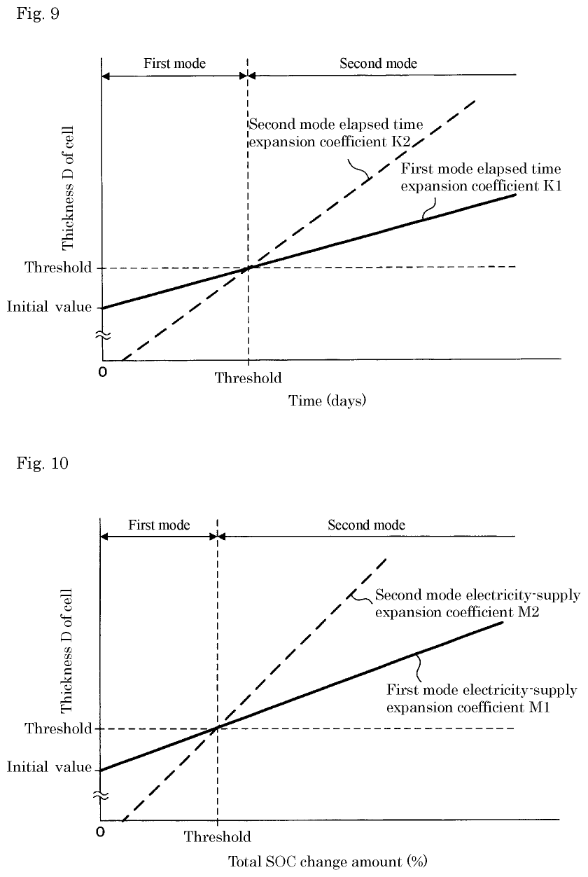

FIG. 9 is a graph illustrating a method of estimating a change in shape of an energy storage device when the energy storage device has been left. In FIG. 9, time (elapsed time)(days) is taken on an axis of abscissas, and a thickness D of the cell is taken on an axis of ordinates. The thickness D of the cell is a thickness of the cell case (see FIG. 2). Alternatively, an amount of change in thickness of the cell or a rate of change in thickness of the cell may be taken on an axis of ordinates. A first mode elapsed time expansion coefficient K1 is expressed by a straight-line gradient indicated by a solid line, and a second mode elapsed time expansion coefficient K2 is expressed by a straight-line gradient indicated by a broken line. The thickness D of the cell in the first mode can be obtained by a function F1 expressed by the expression D=F1 (K1, t). In the expression, K1 represents a first mode elapsed time expansion coefficient, and t represents time. The thickness D of the cell in the second mode can be obtained by a function F2 expressed by the expression D=F2 (K2, t). In the expression, K2 represents a second mode elapsed time expansion coefficient, and t represents time. The function F1 (or the first mode elapsed time expansion coefficient K1) and the function F2 (or the second mode elapsed time expansion coefficient K2) may be stored in the storage unit 53. Alternatively, the functions F1 and F2 may be respectively configured by an arithmetic operation circuit.

In the initial stage of the estimation of a change in shape, the estimation unit 57 calculates the thickness D of the cell using the function F1. Here, the variable t in the function F1 and the value D obtained by the function F1 are referred to as progress parameters. That is, the estimation unit 57 estimates a change in shape of the energy storage device with the lapse of time, and simultaneously calculates the progress parameter.

The determination unit 56 determines the shape change mode based on the progress parameter calculated by the estimation unit 57 and a predetermined threshold value. It is sufficient that the progress parameter a parameter for determining whether the shape change mode of the energy storage device is the first mode or the second mode. In the example illustrated in FIG. 9, an elapsed time t may be used, or the thickness D of the cell may be used as the progress parameter. The thickness D of the cell may be the thickness itself (an absolute value), or may be a change amount from an initial value of the thickness. With such a configuration, for example, it is possible to accurately estimate a change in shape of the energy storage device in a standing state (a state where electricity is not supplied to the energy storage device).

As illustrated in FIG. 9, when the elapsed time becomes equal to or more than a threshold value or when the thickness of the cell becomes equal to or more than a threshold value, the estimation unit 57 calculates the thickness D of the cell using the function F2. With such a configuration, for example, it is possible to accurately estimate a change in shape of the energy storage device in a standing state (a state where electricity is not supplied to the energy storage device).

FIG. 10 is a graph illustrating a method of estimating a change in shape of the energy storage device in a state where electricity is supplied to the energy storage device. In FIG. 10, time (an elapsed time) (days) is taken on an axis of abscissas, and a thickness D of the cell is taken on an axis of ordinates Alternatively, a total SOC change amount (%) may be taken on the axis of abscissas. A first mode electricity-supply expansion coefficient M1 is expressed by a straight-line gradient indicated by a solid line, and a second mode electricity-supply expansion coefficient M2 is expressed by a straight-line gradient indicated by a broken line. The thickness D of the cell in the first mode can be obtained by a function G1 that is expressed by the expression D=G1 (M1, t). In the expression, M1 represents a first mode electricity-supply expansion coefficient, and t represents time. The thickness D of the cell in the second mode can be obtained by a function G2 that is expressed by the expression D=G2 (M2, t). In the expression, M2 represents a second mode electricity-supply expansion coefficient, and t represents time. The function G1 (or the first mode electricity-supply expansion coefficient M1) and the function G2 (or the second mode electricity-supply expansion coefficient M2) may be stored in the storage unit 53. Alternatively, the functions G1 and G2 may be respectively configured by an arithmetic operation circuit.

In the initial stage of the estimation of a change in shape, the estimation unit 57 calculates the thickness D of the cell using the function G1. In the expression, the variable t in the function G1 and the value D obtained by the function G1 are referred to as progress parameters. That is, the estimation unit 57 estimates a change in shape of the energy storage device with the lapse of time, and simultaneously calculates the progress parameter.

The determination unit 56 determines the shape change mode based on the progress parameter calculated by the estimation unit 57 and a predetermined threshold value. It is sufficient that the progress parameter a parameter for determining whether the shape change mode of the energy storage device is the first mode or the second mode. In the example illustrated in FIG. 10, an elapsed time t may be used, or the thickness D of the cell may be used as the progress parameter. The thickness D of the cell may be the thickness itself (an absolute value), or may be a change amount from an initial value of the thickness. With such a configuration, for example, it is possible to accurately estimate a change in shape of the energy storage device in a state where electricity is supplied to the energy storage device.

As illustrated in FIG. 10, when the elapsed time becomes equal to or more than a threshold value or when the thickness of the cell becomes equal to or more than a threshold value, the estimation unit 57 calculates the thickness D of the cell using the function G2. With such a configuration, for example, it is possible to accurately estimate a change in shape of the energy storage device in a state where electricity is supplied to the energy storage device.

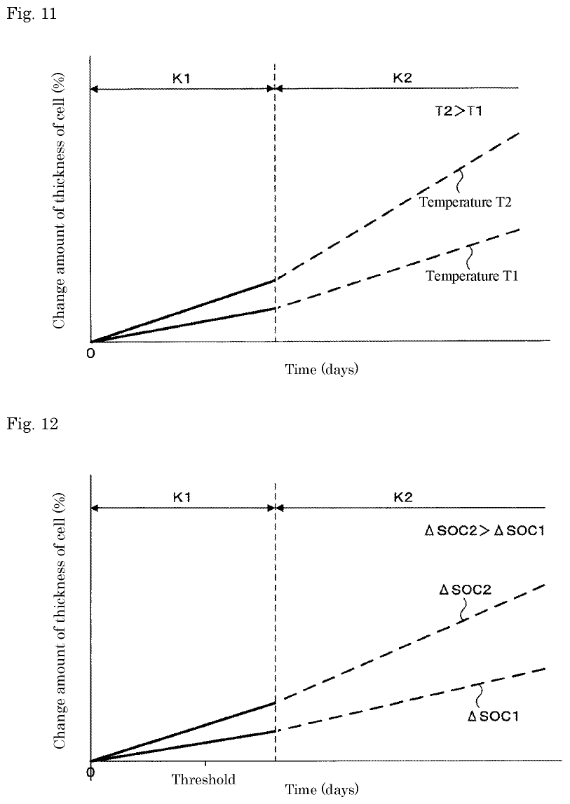

FIG. 11 is a graph illustrating the relationship between a first mode elapsed time expansion coefficient K1 and a second mode elapsed time expansion coefficient K2 and a temperature. In FIG. 11, time (days) is taken on an axis of abscissas, and a change amount (%) of the thickness of the cell is taken on an axis of ordinates. FIG. 11 illustrates: a straight line formed of a solid line that has a first mode elapsed time expansion coefficient K1 as a gradient at temperatures T1 and T2 (>T1), and straight line formed of a broken line that has a second mode elapsed time expansion coefficient K2 as a gradient at the temperatures T1 and T2. As shown in FIG. 11, as the temperature T is increased, the value of the first mode elapsed time expansion coefficient K1 and the value of the second mode elapsed time expansion coefficient K2 are increased. In FIG. 11, for the sake of convenience, only the temperatures T1 and T2 are illustrated. However, by storing a first mode elapsed time expansion coefficient K1 and a second mode elapsed time expansion coefficient K2 that are associated with each predetermined temperatures in the storage unit 53, the optimum first mode elapsed time expansion coefficient K1 and the optimum second mode elapsed time expansion coefficient K2 can be used in accordance with an ambient temperature around the energy storage device. Although not illustrated in the drawing, the first mode electricity-supply expansion coefficient M1 and the second mode electricity-supply expansion coefficient M2 at the time of supplying electricity to the energy storage device are similarly stored in the storage unit 53. Alternatively, it may be also possible to use an arithmetic operation circuit that formulates the first mode elapsed time expansion coefficient and the second mode elapsed time expansion coefficient as functions of temperature and to perform the formulated arithmetic operations.

FIG. 12 is a graph illustrating the relationship between a first mode elapsed time expansion coefficient K1 and a second mode elapsed time expansion coefficient K2 and ΔSOC. In FIG. 12, time (days) is taken on an axis of abscissas, and a change amount (%) of the thickness of the cell is taken on an axis of ordinates. FIG. 12 illustrates: a straight line formed of a solid line that has a first mode elapsed time expansion coefficient K1 at a ΔSOC1 and a ΔSOC2 (>ΔSOC1) as a gradient, and a straight line formed of a broken line that has a second mode elapsed time expansion coefficient K2 at the ΔSOC1 and the ΔSOC2 as a gradient. As illustrated in FIG. 12, as the ΔSOC is increased, the value of the first mode elapsed time expansion coefficient K1 and the value of the second mode elapsed time expansion coefficient K2 are increased. In FIG. 12, for the sake of convenience, only the ΔSOC1 and the ΔSOC2 are illustrated. However, by storing a first mode elapsed time expansion coefficient K1 and a second mode elapsed time expansion coefficient K2 that are associated with each predetermined ΔSOC in the storage unit 53, the optimum first mode elapsed time expansion coefficient K1 and the optimum second mode elapsed time expansion coefficient K2 can be used in accordance with the ΔSOC of the energy storage device. Although not illustrated in the drawing, the first mode electricity-supply expansion coefficient M1 and the second mode electricity-supply expansion coefficient M2 at the time of supplying electricity to the energy storage device are similarly stored in the storage unit 53. Alternatively, it may be also possible to use an arithmetic operation circuit that formulates the first mode elapsed time expansion coefficient and the second mode elapsed time expansion coefficient as functions of the ΔSOC and performs the formulated arithmetic operations.

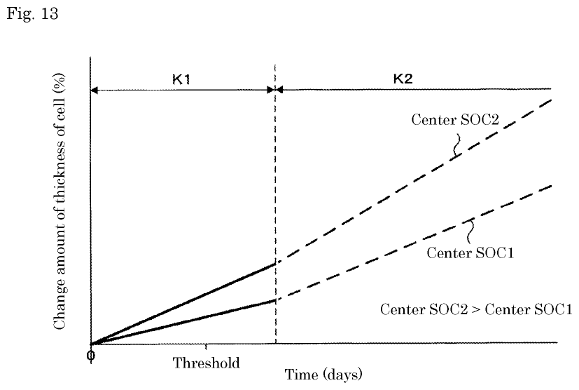

FIG. 13 is a graph illustrating the relationship between a first mode elapsed time expansion coefficient K1 and a second mode elapsed time expansion coefficient K2 and center SOCs. In FIG. 13, time (days) is taken on an axis of abscissas, and a change amount (%) of the thickness of the cell is taken on an axis of ordinates. FIG. 13 illustrates: straight lines each formed of a solid line that have a first mode elapsed time expansion coefficient K1 at a center SOC1 and at a center SOC2 (>center SOC1) as a gradient, and straight lines each formed of a broken line that have a second mode elapsed time expansion coefficient K2 at the center SOC1 and the center SOC2 as a gradient. As illustrated in FIG. 13, the value of the first mode elapsed time expansion coefficient K1 and the value of the second mode elapsed time expansion coefficient K2 are changed depending on the center SOC. In FIG. 13, for the sake of convenience, only the center SOC1 and the center SOC2 are illustrated. However, by storing a first mode elapsed time expansion coefficient K1 and a second mode elapsed time expansion coefficient K2 that are associated with respective predetermined center SOCs in the storage unit 53, the optimum first mode elapsed time expansion coefficient K1 and the optimum second mode elapsed time expansion coefficient K2 can be used in accordance with the center SOCs of the energy storage device. Although not illustrated in the drawing, the first mode electricity-supply expansion coefficient M1 and the second mode electricity-supply expansion coefficient M2 at the time of supplying electricity to the energy storage device are similarly stored in the storage unit 53. Alternatively, it may be also possible to use an arithmetic operation circuit that formulates the first mode elapsed time expansion coefficient and the second mode elapsed time expansion coefficient as functions of the center SOCs and performs the formulated arithmetic operations.

The determination unit 56 may determine the shift from the first mode to the second mode in response to a type of at least one of a positive active material and a negative active material of the energy storage device. It is considered that the energy storage devices having different active materials differ from each other in a shifting point of time from the first mode to the second mode even if these energy storage devices have the same use environment, the same sizes, and the same element structure. In the case of a lithium ion battery, lithium ions are adsorbed into the active material or lithium ions are desorbed from the active material along with charging or discharging. A shape change speed differs depending on whether a type of at least one of a positive active material and a negative active material is an active material that exhibits a large change in volume at the time of adsorption or desorption of ions or an active material that exhibits a small change in volume at the time of adsorption or desorption of ions. Accordingly, it is possible to determine a point of time at which the shape change mode is shifted from the first mode to the second mode. For example, when the positive active material is a lithium nickel oxide-based material, a change in volume of the positive active material at the time of adsorption or desorption of ions is relatively large and hence, it can be determined that the shift from the first mode to the second mode is relatively early.

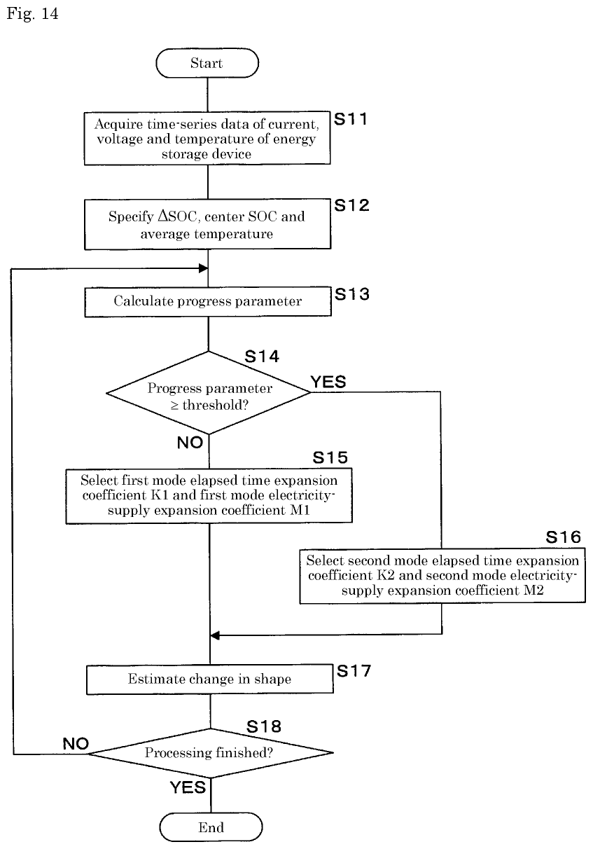

FIG. 14 is a flowchart illustrating processing steps of the shape estimation performed by the estimation device 50. Hereinafter, for the sake of convenience, the description is made by assuming the subject of the processing is the control unit 51. The control unit 51 acquires time-series data of the current, the voltage, and the temperature of the energy storage device together with the time data (S11), and specifies the ΔSOC, the center SOC, and the average temperature (S12). When the energy storage device is left, the ΔSOC, the center SOC, and the average temperature of the energy storage device are acquired. When the energy storage device is in a non-electricity-supply state (a standing state) after an electricity supply state, it is sufficient to specify a ΔSOC, a center SOC, and an average temperature immediately before the non-electricity-supply state.

The control unit 51 calculates a progress parameter (S13) and determines whether the calculated progress parameter is equal to or more than a threshold value or not (S14). When the progress parameter is not more than the threshold value (NO in S14), the control unit 51 selects the first mode elapsed time expansion coefficient K1 and the first mode electricity-supply expansion coefficient M1 (S15), and estimates a change in shape (S17).

When the progress parameter is equal to or more than the threshold (YES in S14), the control unit 51 selects the second mode elapsed time expansion coefficient K2 and the second mode electricity-supply expansion coefficient M2 (S16), and performs processing in step S17.

The control unit 51 determines whether or not to finish the processing (S18). When the control unit 51 does not finish the processing (NO in S18), the control unit 51 continues the processing in step S13 and the succeeding steps. When the control unit 51 finishes the processing (YES in S18), the processing is finished.

In a case where an electricity supply state and an electricity non-supply state coexist in mixture as a state of the energy storage device, the shape estimation can be obtained as a sum of a lapsed time swelling amount (a change in shape when the energy storage device is left in a standing state) and an electricity-supply swelling state (a change in shape when electricity is supplied to the energy storage device) that are calculated using lapsed time expansion coefficients (K1, K2) and electricity-supply expansion coefficients (M1, M2).

The estimation device 50 can also be realized using a general-purpose computer including a CPU (a processor), a RAM (a memory), and the like. That is, a computer program that determines processing in the respective steps as illustrated in FIG. 14 is loaded into the RAM (the memory) incorporated in a computer, and the computer program is executed by the CPU (the processor) so as to realize the estimation device 50 on the computer. The computer program may be recorded in a recording medium and may be distributed.

As described above, according to the present embodiment, in the development stage or the designing stage of the energy storage device, it is possible to estimate a change in shape (a change in thickness) at the end of the life of the energy storage device. Accordingly, it is possible to perform designing of an optimum battery module in consideration of the shape (thickness) of the energy storage device at the end of the life. Accordingly, excessive large sizing of the battery module can be avoided, the reduction of cost can be achieved, and the maximum battery performance can be achieved.

In this embodiment, mainly, the swelling of the element structure has been described. Besides the swelling of the element structure, the present embodiment is also similarly applicable to a change in shape of the energy storage device due to a gas generated from an electrolyte solution at the time of overcharging or the like. In the present embodiment, the case has been described where the energy storage device includes the prismatic cell case (for example, made of metal). Alternatively, the energy storage device may be a so-called pouch cell where a case is formed using a laminate film.

The embodiment has been disclosed for an exemplifying purpose in all respects and is not limitative. The scope of the present invention is defined by the claims, and includes all modifications equivalent to the present invention within the meaning and the scope of the claims.

1. An estimation device comprising:
a determination unit configured to determine whether a shape change mode of an energy storage device is a first mode or a second mode; and
an estimation unit configured to estimate a change in shape of the energy storage device in response to the shape change mode determined by the determination unit.

2. The estimation device according to claim 1, wherein the energy storage device includes a wound electrode assembly.

3. The estimation device according to claim 1, wherein a shape change speed in the second mode shifted from the first mode is larger than a shape change speed in the first mode.

4. The estimation device according to claim 1, further comprising a first acquisition unit configured to acquire or calculate a progress parameter relating to an elapsed period of the energy storage device, wherein the determination unit is configured to determine the shape change mode based on the progress parameter acquired or calculated by the first acquisition unit.

5. The estimation device according to claim 1, further comprising a second acquisition unit configured to acquire or calculate a progress parameter relating to supply of electricity to the energy storage device, wherein the determination unit is configured to determine the shape change mode based on the progress parameter acquired or calculated by the second acquisition unit.

6. The estimation device according to claim 4, wherein the progress parameter includes any one of the number of elapsed days in a time period during which electricity is not supplied to the energy storage device or in a time period during which electricity is supplied to the energy storage device, absolute values of sizes of the energy storage device, a change amount of a shape of the energy storage device, and a total SOC change amount of the energy storage device.

7. The estimation device according to claim 1, wherein the determination unit is configured to determine a shift from the first mode to the second mode in response to a type of at least one of a positive active material and a negative active material of the energy storage device.

8. The estimation device according to claim 2, wherein the change in shape includes a change in thickness of the wound electrode assembly.

9. A computer program configured to cause a computer to perform processing of determining whether a shape change mode of an energy storage device is a first mode or a second mode, and perform processing of estimating a change in shape of the energy storage device in response to the determined shape change mode.

10. An estimation method comprising the steps of:
determining whether a shape change mode of an energy storage device is a first mode or a second mode; and
estimating a change in shape of the energy storage device in response to the determined shape change mode.

11. The estimation device according to claim 2, wherein a shape change speed in the second mode shifted from the first mode is larger than a shape change speed in the first mode.

12. The estimation device according to claim 5, wherein the progress parameter includes any one of the number of elapsed days in a time period during which electricity is not supplied to the energy storage device or in a time period during which electricity is supplied to the energy storage device, absolute values of sizes of the energy storage device, a change amount of a shape of the energy storage device, and a total SOC change amount of the energy storage device.
